(19) United States
(12) Patent Application Publication
(10) Pub. No.: US 2013/0038027 A1
(43) Pub. Date: Feb. 14, 2013

(54) Manifold Gasket Assembly

(71) Applicants: Michael Peter Feldner, Germantown, WI (US); Neal C. Hobbs, Grafton, WI (US)

(72) Inventors: Michael Peter Feldner, Germantown, WI (US); Neal C. Hobbs, Grafton, WI (US)

(21) Appl. No.: 13/206,104

(22) Filed: Aug. 9, 2011

(51) Int. Cl. F02F 11/00; F16J 15/02

(52) U.S. Cl. 277/591; 277/628

(57) ABSTRACT

A gasket assembly for sealing an interface between two objects having a passage for a coolant fluid includes a gasket element having at least one opening through which the coolant flows. The gasket assembly also includes at least one coolant seal disposed in the opening. The coolant seal includes a ring and a protective cover that reduces the surface area of the ring that is in direct contact with the coolant.

### TECHNICAL FIELD

The subject matter disclosed in this application relates to gaskets and gasket assemblies. More specifically, but not by way of limitation, the present application relates gasket assemblies for use with an exhaust manifold in internal combustion engines.

### BACKGROUND

Internal combustion engines typically include a cylinder head disposed above cylinders on top of a cylinder block. The cylinder head forms the combustion chamber by enclosing the cylinder. The cylinder head may include ports for the fuel/air, exhaust gases and coolant. The joint between the cylinder head and the cylinder is typically sealed by a gasket (head gasket). The gasket fills the space at the joint between the two mating surfaces to prevent leakage. In some engines a gasket is used to seal the interface between the cylinder head and the exhaust manifold, and in applications where the exhaust manifold is water cooled, the same gasket is used to seal a coolant passage and an exhaust port.

Gaskets that seal a coolant passage and an exhaust port operate in a severe environment. There may be a steep temperature gradient between the exhaust port and the coolant passage. For example, an exhaust port may have a temperature of approximately 1300° F. (704° C.) while the coolant passage may have a temperature of approximately 180° F. (82° C.). Additionally, there is a problem with the coolant chemically reacting with the materials used in the gasket components. This severe environment may cause failure of the gasket components. Significant damage to the engine may occur if the gasket fails. The damage may result from exhaust gases being injected into the cooling system, or coolant leaking into the cylinders or exhaust.

Furthermore, there may be significant space constraints when the gasket is changed on an engine. Typically, the cylinder head and exhaust manifold remain rigidly fixed to the engine when the gasket flange mounting bolts are removed so there is very little space available to remove and replace gaskets.

There are a number of known gasket configurations for improving the performance of the gaskets. For example, copper o-rings may be provided around the coolant passage to prevent leakage. However, the copper o-rings do not expand and contract sufficiently with temperature changes. Also, because of the aforementioned space constraint, field technicians occasionally strike the o-ring with a hammer in order to fit the gasket into the application. Both of these conditions may cause gasket failure resulting in coolant leaks.

Another known gasket configuration includes an EPDM material (ethylene propylene diene monomer) grommet that is glued to the inner diameter of a copper o-ring. The grommet may be exposed to temperatures as high as approximately 313° F. (156° C.). In many cases, the EPDM material cannot withstand the high application temperature to which it is exposed. Also, because the grommet ID is smaller than the coolant passage the grommet may be damaged by the flow of coolant in the coolant passage. This known design may adequately seal the exhaust port but does not effectively seal the coolant passage.

### BRIEF DESCRIPTION OF THE INVENTION

Thus, there is a need for a gasket assembly that effectively seals the exhaust port and the coolant passage and that is not susceptible to failure resulting from the extreme temperature gradients and exposure to the coolant.

In some embodiments a gasket assembly is provided including a gasket element having at least one opening through which the coolant flows; and at least one coolant seal disposed in the opening. The coolant seal includes a ring and a protective cover that reduces the surface area of the ring that is in direct contact with the coolant.

In some embodiments the ring in the coolant seal may be a grommet of elastomeric material.

In some embodiments the protective cover in the coolant seal may be a metal ferrule disposed along the internal surface of the grommet.

In other embodiments, the gasket element in the gasket assembly includes an inner core and a plate of uniform thickness encasing the inner core.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 represents a plan view of a gasket assembly.

FIG. 2 is a cross section AA taken through the gasket assembly in FIG. 1.

FIG. 3 is a cross section BB taken through the gasket assembly in FIG. 1.

FIG. 4 represents a side view of a particular embodiment of a coolant seal.

FIG. 5 is a plan view of a particular embodiment of a coolant seal.

FIG. 6 is a cross section CC taken through the coolant seal in FIG. 5.

FIG. 7 represents a side view of another embodiment of a coolant seal.

FIG. 8 is a plan view of another embodiment of a coolant seal.

FIG. 9 is a cross section DD taken through the coolant seal in FIG. 8.

### DETAILED DESCRIPTION OF THE INVENTION

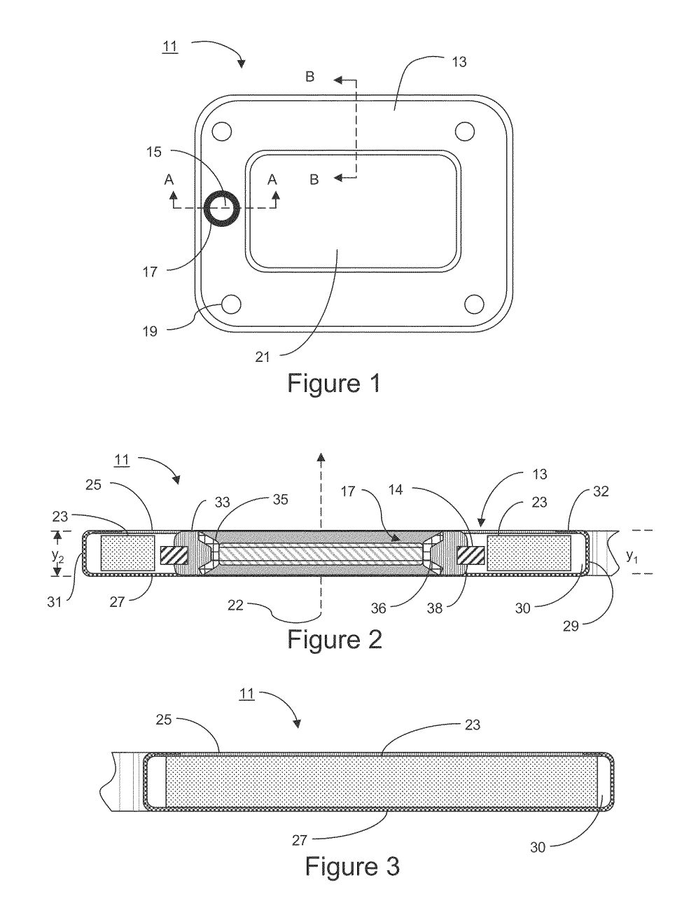

Referring now to the figures, where the various numbers represent like parts throughout the several views, FIG. 1 is a plan view of an exemplary embodiment of a gasket assembly 11. The gasket assembly 11 includes a gasket element 13 provided with a coolant opening or passage 15, a coolant seal 17, one or more bolt holes 19 and an exhaust opening 21. One use of the gasket assembly 11 is to seal surfaces between a cylinder head and an exhaust manifold on an internal combustion engine where the exhaust manifold is cooled with fluid coolant. When the engine is in operation the exhaust flows through the exhaust opening 21 and coolant flows through the coolant opening 15 along an axis 22.

As illustrated in FIGS. 2 and 3, the gasket element 13 includes a core 23 surrounded by an upper plate 25 and a lower plate 27. The core 23 may be made of a number of materials suitable for gasket applications, such as, expanded graphite, expanded polytetraflouroethylene (PTFE), vermiculite, and the like.

In one embodiment, the gasket element 13 is a three layer element with core 23 made of vermiculite and ceramic fiber bonded with nitrile rubber binder (NBR) sandwiched between a metal upper plate 25 and a metal lower plate 27. The metal upper plate 25 and the metal lower plate 27 may be of similar thickness, generally about 0.010 inches (0.254 mm). One embodiment of the metal plates comprises mild steel metal plates. In another embodiment, the core 23 may be an inorganic mineral fiber-based core such as those used with a mechanically clad composite (MCC) gasket. The gasket element 13 performs well in extreme heat environment (to 1800° F., 982° C.) and provides strength, durability and protection from tear and distortion during field installation.

Also included in the gasket element 13 are an inner fire ring 29 and an outer fire ring 31. The purpose of the inner fire ring 29 and the outer fire ring 31 is to provide an additional mechanical seal of the hot exhaust gases, and to make the gasket assembly 11 more robust against installation damage. In one embodiment, the inner fire ring 29, and the outer fire ring 31 may be formed by an overlap 32 of the lower plate 27 and the upper plate 25. An air space 30 may be provided between the inner surface of the inner fire ring 29 and the core 23. It would be apparent to one skilled in the art that several types of fire ring configurations may be used, including but not limited to fire rings bonded to the core 23, fire rings that are separate components from the gasket element 13, and fire rings comprised of metallic O-rings.

In one embodiment, the width of the inner fire ring 29 (referenced as y₁ in FIG. 2, and measured from outer surface of the lower plate 27 to the outer surface of the upper plate 25 in the direction of axis 22) is greater than the width of the outer fire ring 31 (referenced as y₂ in FIG. 2). For example, in one embodiment the thicknesses of the lower plate 27 and the upper plate 25 are approximately 0.010 inches (0.254 mm), the thickness of the core 23 is approximately 0.063 inches (1.6 mm) and the thickness of the inner fire ring 29 is formed to exceed the thickness of the outer fire ring 31 by about 0.015 in. (0.381 mm) (prior to installation). The slightly thicker inner fire ring 29 enables the gasket assembly 11 to absorb full bolt load for maximum exhaust sealing.

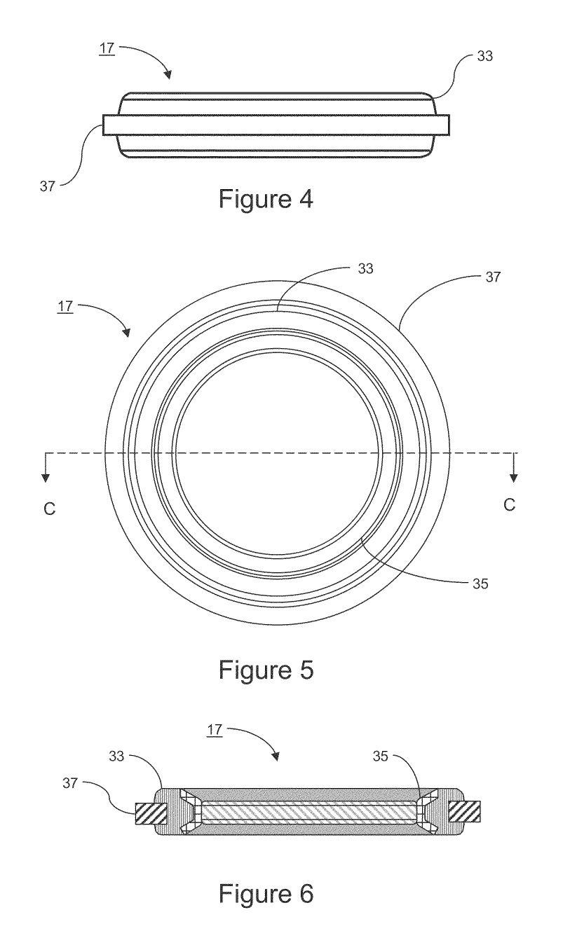

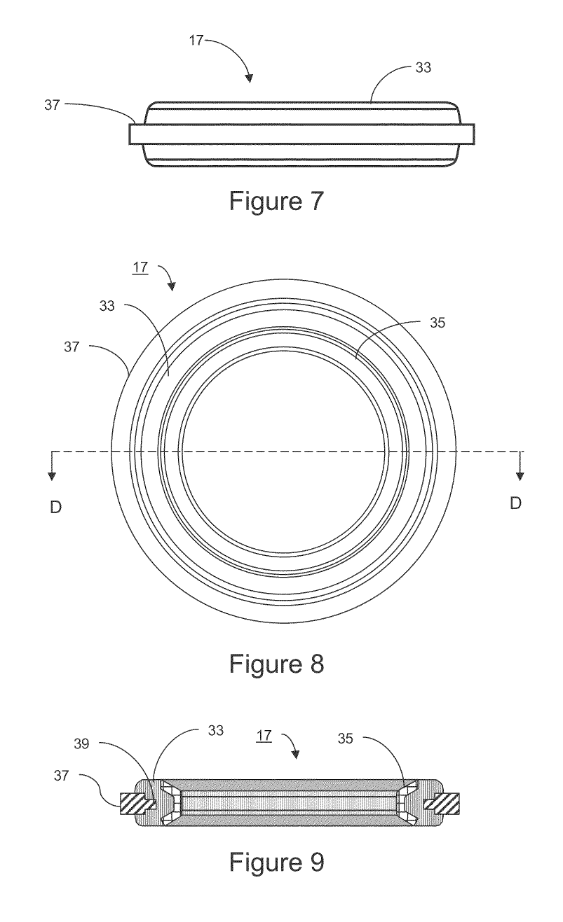

Embodiments of the coolant seal 17 are best illustrated with reference to FIGS. 4-9. In one embodiment, the coolant seal 17 comprises a ring 33, for example a grommet; a protective cover 35, such as for example a ferrule or sleeve; and an annular plate 37, such as a washer. The ring 33 includes an inner periphery 36 comprised of the surface of the ring 33 proximate to the axis 22 and an outer periphery 38 comprised of the surface of the ring 33 distal from the axis 22. The protective cover 35 is disposed on the inner periphery 36 of the ring 33. The annular plate 37 is disposed along the outer periphery 38 of the ring 33 which is molded to the annular plate 37. The annular plate 37 may be positioned in a groove in the ring 33. The annular plate 37 serves to maintain the coolant seal 17 within the gasket assembly 11 and between plates 25, 27. The protective cover 35 is disposed substantially along the inner periphery 36 of the ring 33. The protective cover 35 serves to significantly reduce the surface area of the ring 33 that is in contact with the coolant and to distribute the heat from the coolant to provide a more uniform temperature distribution along the inner surface of the ring 33. Additionally, any forces exerted on the ring 33 by the flow of the coolant are more evenly distributed thereby protecting the ring from friction wear, abrasion and other damage. The protective cover 35 improves the durability of the coolant seal 17. In some embodiments, the protective cover 35 assists the ring 33 in providing a coolant seal. This includes, in some embodiments, the protective cover 35 providing the majority of the sealing function. The ring 33 may be made of an elastomeric material capable of withstanding the high temperatures that components of the gasket assembly 11 may be exposed to, and that provides resistance to taking a set from compression after being installed. An example of such an elastomeric material is a high temperature fluorocarbon (Parco 9009-75). The protective cover 35 may be made of metal or other material that is substantially inert to coolants such as glycol, is preferably ductile or malleable, and retains its shape after being formed or reshaped. The protective cover 35 may also be made of metal or other material that is an efficient heat conductor. Metals suitable for the protective cover 35 may include bronze, brass, iron, steel, stainless steel, and aluminum. In one embodiment the protective cover 35 is a ferrule made of copper. In other embodiments, the protective cover 35 may have a substantially U-shaped cross-section, or a substantially V-shaped cross-section, or a partially V-shaped cross-section. In another embodiment, the protective cover 35 cross-section may have a shape that maintains the protective cover 35 at least in part in an elastically-deformed state in order to maintain sealing as the exhaust manifold and other engine components expand and contract due to temperature fluctuations. Other configurations of a protective cover 35 may include other means of protecting the ring 33, such as a coating of the ring 33 with materials that are resistant to high temperature and abrasion. The annular plate 37 may be a metal washer. In one embodiment the annular plate 37 is a steel washer.

Illustrated in FIG. 9 is a cross section of an alternate embodiment of the coolant seal 17 where the annular plate 37 is provided with a reduced thickness or step 39 adapted to engage a corresponding notch in the ring 33. In that embodiment, the annular plate 37 is annular in shape with a reduced width along the internal surface of the annulus.

Preferably, the thickness of the coolant seal 17 is approximately equal to the thickness of the inner fire ring 29. This eases the field installation process and mitigates the risk of installation damage by eliminating the need to strike the seal with a hammer

When in use, the gasket assembly 11 provides an effective seal against leakage of coolant by means of the coolant seal 17. Additionally, the inner fire ring 29 and the outer fire ring 31 provide structural integrity that makes the gasket assembly 11 more robust against installation damage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A gasket assembly for sealing an interface between two objects having a passage for a coolant fluid comprising:
a gasket element having at least one opening through which the coolant flows; and
at least one coolant seal disposed in the opening comprising:
a ring and
a protective cover that reduces the surface area of the ring that is in direct contact with the coolant.

2. The gasket assembly of claim 1 wherein the ring comprises a grommet of elastomeric material, the grommet including an inner periphery and an outer periphery.

3. The gasket assembly of claim 2 wherein the protective cover comprises a ferrule disposed along the inner periphery of the grommet.

4. The gasket assembly of claim 2 wherein the at least one coolant seal further comprises an annular plate disposed along the outer periphery of the grommet.

5. The gasket assembly of claim 4 wherein the annular plate comprises an annulus having a reduced width along the outer periphery of the annulus.

6. The gasket assembly of claim 3 wherein the ferrule is made of copper.

7. The gasket assembly of claim 1 wherein the gasket element is provided with an opening for an exhaust port.

8. The gasket assembly of claim 1 wherein the gasket element comprises:
an inner core; and
at least one plate having substantially uniform thickness encasing the inner core.

9. The gasket assembly of claim 8 further comprising:
an outer fire ring disposed around the outer periphery of the gasket element; and
an inner fire ring disposed around the opening for the exhaust port wherein the inner fire ring is thicker than the outer fire ring.

10. The gasket assembly of claim 9 further comprising:
an air space disposed between the inner fire ring and the inner core.

11. A coolant seal for use in a gasket assembly for sealing the surfaces of an exhaust manifold that is cooled with a fluid coolant and the cylinder head of an internal combustion engine, the coolant seal comprising:
a ring; and
a protective cover that reduces the surface area of the ring that is in direct contact with the coolant.

12. The coolant seal of claim 11 wherein the ring comprises a grommet of elastomeric material, the grommet including an inner periphery and an outer periphery.

13. The coolant seal of claim 12 wherein the protective cover comprises a ferrule disposed along the inner periphery of the grommet.

14. The coolant seal of claim 12 further comprising an annular plate disposed along the outer periphery of the grommet.

15. The coolant seal of claim 14 wherein the annular plate comprises an annulus having a reduced width along the internal surface of the annulus.

16. The coolant seal of claim 13 wherein the ferrule is made of copper.

17. A gasket assembly for sealing an interface between a cylinder head having a passage for a coolant and an exhaust manifold comprising:
a gasket element having at least one opening through which the coolant flows; and
at least one coolant seal disposed about the opening comprising:
a ring and
means for protecting the ring.

18. The gasket assembly of claim 17 wherein the means for protecting the ring distributes heat transferred from the coolant about the ring to provide a more uniform temperature along the inner surface of the ring.

19. The gasket assembly of claim 17 wherein the means for protecting the ring distributes force from the coolant flow about the ring to provide more uniform forces along the ring.

20. The gasket assembly of claim 17 wherein the means for protecting the ring reduces the amount of coolant that contacts the ring.
